(19) United States
(12) Patent Application Publication
(10) Pub. No.: US 2018/0228166 A1
(43) Pub. Date: Aug. 16, 2018

(54) ENVIRONMENTAL IMPROVEMENT MATERIAL AND MANUFACTURING METHOD THEREOF

(71) Applicant: UD, INC., Kawasaki-shi (JP)

(72) Inventors: Teruo Kosaka, Yokohama-shi (JP); Mitsuo Tsukano, Kawasaki-shi (JP); Hiroaki Yoshida, Wakkanai-shi (JP)

(73) Assignee: Yoshiken Co., Ltd., Wakkanai-shi (JP)

(21) Appl. No.: 15/948,222

(22) Filed: Apr. 9, 2018

Related U.S. Application Data
(62) Division of application No. 15/392,373, filed on Dec. 28, 2016.

(30) Foreign Application Priority Data
May 13, 2016 (JP) 2016-097189
Jul. 29, 2016 (JP) 2016-150027

(51) Int. Cl. A01N 65/03; A01N 59/00

(52) U.S. Cl. CPC A01N 65/03; A01N 59/00

(57) ABSTRACT

An environmental improvement material includes granulated and/or powderized Wakkanai diatom shale that has been subjected to a sterilization treatment and provides a disinfecting, sterilizing, or deactivating function, and disinfects, sterilizes, or deactivates microorganisms.

### CROSS REFERENCE TO RELATED APPLICATIONS

This application is a divisional of U.S. patent application Ser. No. 15/392,373 filed Dec. 28, 2016, which claims priority to Japanese Patent Application No. 2016-150027, filed Jul. 29, 2016, and Japanese Patent Application No. 2016-097189, filed May 13, 2016. Each of these application is incorporated herein by reference in its entirety.

### TECHNICAL FIELD

The present invention relates to an environmental improvement material that is capable of improving and enhancing environmental hygiene by disinfecting, sterilizing, or deactivating microorganisms including general bacteria, such as Escherichia coli (E. coli) and staphylococcus aureus, and non-cellular organisms, such as viruses, and a manufacturing method thereof.

### BACKGROUND ART

Wakkanai diatom shale (geological name: Wakkanai layer diatom shale), also referred to as Wakkanai diatomite, provides an excellent moisture control function while being a natural material. Therefore, Wakkanai diatom shale has, heretofore, been used in housing construction materials such as a material for walls. Wakkanai diatom shale has also recently been used in deodorizing products that take advantage of a deodorizing function thereof. Commercial products utilizing the functions provided by Wakkanai diatom shale are being created.

Wakkanai diatom shale is hard shale that tends to break into fine pieces. Wakkanai diatom shale is formed by the remains (mainly composed of amorphous silica) of diatom, which is microscopic plankton, deposited in the deep sea in the late Miocene of the Neogene period (about twelve million to seven million years ago) being gradually compacted and hardened.

A study conducted by Hokkaido-ritsu Shigen Kenkyujo (Hokkaido Prefectural Resources Research) (currently the Geological Survey of Hokkaido, Hokkaido Research Organization) indicates that a large amount of Wakkanai diatom shale is distributed in the Dohoku Tenpoku region that mainly centers on Wakkanai.

As shown in FIG. 1, the Wakkanai diatom shale has numerous micropores (commonly referred to as mesopores) with a pore radius of 1 nm to 10 nm (nanometer: 1 nm is equivalent to one millionth of a millimeter). Meanwhile, diatomite produced in other regions in Japan, such as Akita, Ishikawa, Okayama, and Oita, mainly has large pores (commonly referred to as macropores) with a pore radius of 50 nm or greater.

In addition, based on general data on Wakkanai diatom shale, the Wakkanai diatom shale has a total pore volume of about 0.215 cm³/g and a specific surface area of about 128.8 m²/g. Meanwhile, the total pore volume and the specific surface area of the above-described diatomite produced in other regions are about one-fourth to one-sixth that of the Wakkanai diatom shale (based on a joint research report [1994] by the Hokkaido Industrial Research Institute and Hokkaido-ritsu Chika Shigen Chosajo [Hokkaido Underground Resources Institute]).

In recent years, actions have been taken to improve sanitation management in individual cattle farms for the purpose of improving the safety of livestock. As typical sanitation management, management is performed to maintain and improve the cleanliness of cattle farms and reduce the level of bacteria harmful to livestock, for the primary purpose of maintaining the health of livestock.

Antiseptic agents that are conventionally used are effective against pathogens. However, some antiseptic agents are harmful to humans and livestock, and need to be handled with care. Therefore, an environmental improvement material that is harmless to humans and livestock, and provides a function for disinfecting or sterilizing harmful bacteria is needed.

As such an environmental improvement material, an environmental improvement material for cattle farms that uses Wakkanai diatom shale, which is a natural material, has been commercially produced. Diatomite was used during war-time food shortages as a bulking agent in confections and food products, and is a natural material that is harmless to humans and animals.

As described in JP Publication No. 5248703, this product is used as a livestock bedding material produced by granulating and/or powderizing Wakkanai diatom shale, as a material for suppressing microbial growth in barns that tend to become unsanitary due to feces, urine, and the like.

However, based on claim 3 in JP Publication No. 5248703, the livestock bedding material that is a material for suppressing microbial growth in barns provides a function as a “material for suppressing growth, while retaining microorganisms.” The livestock bedding material does not provide a function for disinfecting or sterilizing the microorganisms themselves.

In addition, the product is not subjected to a sterilization treatment. Therefore, bacteria that is already attached to or present in the Wakkanai diatom shale from the time of mining remains as is in the product even after the Wakkanai diatom shale is pulverized into granules or powder. Consequently, this product being scattered as a livestock bedding material means that the bacteria remaining in the product is also scattered at the same time.

When Wakkanai diatom shale that has not been subjected to a sterilization treatment was cultured using a standard agar plate culture method at the Japan Food Research Laboratory, a general bacteria count (viable bacteria count) was determined to be 6.1×10²/g.

### DISCLOSURE OF INVENTION

In light of the above-described issues, an object of the present invention is to provide an environmental improvement material that is capable of disinfecting, sterilizing, or deactivating microorganisms including bacteria and non-cellular organisms, such as viruses, attached to or present in Wakkanai diatom shale itself, and at the same time, disinfecting, sterilizing, or deactivating microorganisms that are externally present, through addition of a disinfecting, sterilizing, or deactivating function to Wakkanai diatom shale, and a manufacturing method thereof.

To achieve the above-described object, focus was placed on the fact that the micropores in Wakkanai diatom shale that have a pore radius of 1 nm to 10 nm have an effect of adsorbing microorganisms. In addition, Wakkanai diatom shale was subjected to a dry-heat sterilization treatment as a disinfecting or sterilizing means.

A typical example of the adsorption effect can be seen in zeolite that serves as a silica-alumina-based adsorbent and activated carbon that serves as a carbon-based adsorbent. Both zeolite and activated carbon adsorb microorganisms through an interfacial phenomenon and a capillary phenomenon of micropores. In addition, zeolite adsorbs water molecules by chemical reaction and activated carbon adsorbs odor molecules that are organic compounds.

Wakkanai diatom shale is a silica-alumina-based compound of which silicon oxide (SiO₂) is a main ingredient. The Wakkanai diatom shale has countless micropores having a pore radius of 1 nm to 10 nm, and a central pore radius of 2 nm to 4 nm. The Wakkanai diatom shale has characteristics that are excellent for the adsorption effect, with a total pore volume of about 0.215 cm³/g and a specific surface area of about 128.8 m²/g. Furthermore, the Wakkanai diatom shale has mild acidity. Therefore, the Wakkanai diatom shale chemically reacts with and adsorbs alkaline substances. In particular, the Wakkanai diatom shale effectively adsorbs basic gas, of which a typical example is ammonia gas. The Wakkanai diatom shale herein also encompasses diatom shale produced in regions other than Wakkanai that has similar physical and chemical properties as the Wakkanai diatom shale. Therefore, “Wakkanai diatom shale” described in the specification below includes diatom shale produced in regions other than Wakkanai that has physical and chemical properties similar to the Wakkanai diatom shale.

The sterilization treatment described above is a sterilization method for completely disinfecting or eliminating microorganisms such as bacteria. Of such sterilization treatments, the dry-heat sterilization treatment is a sterilization method in which a target object is heated in dry air and microorganisms are thereby sterilized.

An environmental improvement material according to claim 1 includes granulated and/or powderized Wakkanai diatom shale that has been subjected to a sterilization treatment and provides a disinfecting, sterilizing, or deactivating function, and disinfects, sterilizes, or deactivates microorganisms.

An environmental improvement material according to claim 2 is the environmental improvement material according to claim 1, in which the Wakkanai diatom shale is contained in a sheet material.

An environmental improvement material according to claim 3 is the environmental improvement material according to claim 2, in which the sheet material is cloth, film, or paper.

An environmental improvement material according to claim 4 is the environmental improvement material according to claim 1, in which the Wakkanai diatom shale is housed in a container.

An environmental improvement material according to claim 5 includes solidified granulated and/or powderized Wakkanai diatom shale that has been subjected to a sterilization treatment and provides a disinfecting, sterilizing, or deactivating function.

A method for manufacturing an environmental improvement material according to claim 6 includes: pulverizing Wakkanai diatom shale into granules and/or a powder; subjecting the granulated and/or powderized Wakkanai diatom shale to a sterilization treatment and imparting the Wakkanai diatom shale with a function for disinfecting, sterilizing, or deactivating microorganisms; and forming the Wakkanai diatom shale into a state of a predetermined environmental improvement material according to any one of claims 1 to 5.

A method for manufacturing an environmental improvement material according to claim 7 is the method for manufacturing an environmental improvement material according to claim 6, in which the sterilization treatment is a dry-heat sterilization treatment.

As described above, Wakkanai diatom shale in a natural state only provides a function for retaining bacteria and suppressing growth thereof. Meanwhile, as a result of the Wakkanai diatom shale being subjected to a sterilization treatment, a revolutionary and novel function was added that enables general bacteria including E. coli and staphylococcus aureus to be disinfected or sterilized and microorganisms such as non-cellular organisms such as viruses to be deactivated.

An environmental improvement material that utilizes the functions of the Wakkanai diatom shale that has been subjected to a sterilization treatment can disinfect or sterilize E. coli and staphylococcus aureus present in feces and urine by being used as an environmental improvement material for livestock, as described in a typical example.

Furthermore, at the same time that daily sanitation measures for cattle barns are improved as a result, the frequency of disinfection operations for the entire cattle barn that have been performed since the past can be reduced.

As a result of the disinfection operations for the cattle barn being reduced in this way, contributions can be made to improving the work environment for workers and reducing cost.

Furthermore, the environmental improvement material is useful as a preservative for food products, as an environmental improvement material providing an antibacterial or antiseptic function for food processing facilities, and as an antibacterial or antiseptic agent for medical use, housing, garbage collection, and the like, as well as in any other field that requires suppression and elimination of bacteria in industrial or living environments.

### BRIEF DESCRIPTION OF DRAWINGS

FIG. 1 is a graph showing a pore radius range of Wakkanai diatom shale.

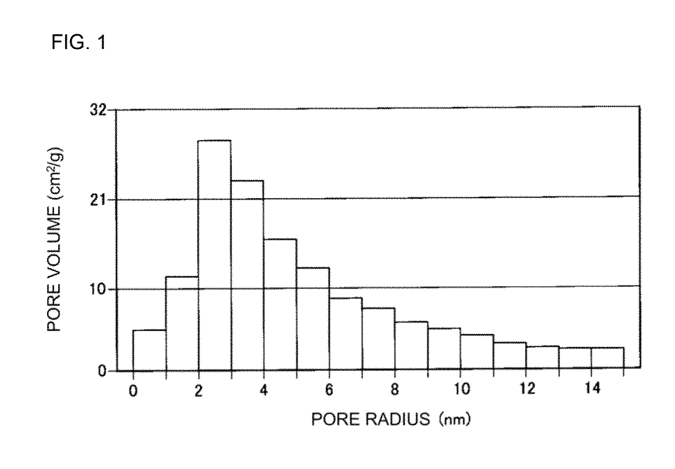

FIG. 2 is a graph showing increases and decreases in test bacteria in samples under differing conditions.

FIG. 3A to FIG. 3G are diagrams showing changes in E. coli depending on whether or not Wakkanai diatom shale subjected to a dry-heat sterilization treatment is added.

FIG. 4A to FIG. 4G are diagrams showing changes in staphylococcus aureus depending on whether or not Wakkanai diatom shale subjected to a dry-heat sterilization treatment is added.

FIG. 5A to FIG. 5G are diagrams showing changes in E. coli depending on whether or not Wakkanai diatom shale not subjected to a dry-heat sterilization treatment is added.

FIG. 6A to FIG. 6G are diagrams showing changes in staphylococcus aureus depending on whether or not Wakkanai diatom shale not subjected to a dry-heat sterilization treatment is added.

FIG. 7A to FIG. 7G are diagrams showing changes in E. coli depending on whether or not Oita-produced diatomite subjected to a dry-heat sterilization treatment is added.

FIG. 8A to FIG. 8G are diagrams showing changes in staphylococcus aureus depending on whether or not Oita-produced diatomite subjected to a dry-heat sterilization treatment is added.

FIG. 9A to FIG. 9G are diagrams showing changes in salmonella depending on whether or not Wakkanai diatom shale subjected to a dry-heat sterilization treatment is added.

### DESCRIPTION OF PREFERRED EMBODIMENTS

To prepare an environmental improvement material using Wakkanai diatom shale, first, Wakkanai diatom shale is mined. The mined Wakkanai diatom shale is then pulverized by a publicly known method, and granules and/or a powder of Wakkanai diatom shale is formed. Based on Wikipedia, the granules and the powder are an aggregate of grains or an aggregate of powder. The powder is smaller than the grain. The grain refers to that of which the size is to an extent that the form thereof is identifiable by the naked eye. Based on rough classifications of grain and powder, grains are 10⁻² m to 10⁻⁴ m (several mm to 0.1 mm) are grains, and powders, in a narrow sense, are 10⁻⁴ m to 10⁻⁹ m (up to several times the size of an atom).

Next, the Wakkanai diatom shale that has been granulated and/or powderized in this way is subjected to a sterilization treatment. For example, a dry-heat sterilization treatment is performed as the sterilization treatment. A principle behind the dry-heat sterilization treatment is that enzymes and proteins of microorganisms and the like attached to the Wakkanai diatom shale are thermally denatured, inactivated, and sterilized as a result of the granulated and/or powderized Wakkanai diatom shale being heated for 30 minutes to two hours at 160° C. to 200° C.

An example of a dry-heat sterilization apparatus used in the dry-heat sterilization treatment is an electric drying furnace that has an openable/closable door on a front surface. The electric drying furnace has an internal volume of 1.2 m (width)×1.0 m (depth)×1.0 m (height). An allowable drying temperature is 150° C. to 200° C. In addition, a plurality of shelf plates are disposed within the electric furnace with space therebetween in the up/down direction. The space between the upper and lower shelves is set such that heated air can sufficiently reach above each rectangular vat, when a rectangular vat is arranged on each shelf.

Dry-heat sterilization by the electric drying furnace is a direct heating method. That is, an electric heating coil is attached to an inner wall of the electric drying furnace. Interior air temperature is raised and held at a predetermined temperature as a result of heating by the electric heating coil. In addition, 300 kg to 500 kg of Wakkanai diatom shale can be sterilized at one time in the electric drying furnace.

As a method for performing the dry-heat sterilization treatment, first, the Wakkanai diatom shale that has been pulverized into granules and/or a powder outside of the electric drying furnace is laid over a bottom surface of an industrial large-size vat at a thickness of 1.0 cm to 1.5 cm. A reason for laying the Wakkanai diatom shale at this relatively thin thickness is to enable heat from above to be evenly transmitted into the Wakkanai diatom shale.

Then, the rectangular vats lined with Wakkanai diatom shale are arranged on the shelves inside the electric drying furnace. After the positions of the rectangular vats arranged on the shelves are confirmed, the door of the electric drying furnace is closed and the air within is heated. After the interior temperature of the electric drying furnace has reached a predetermined temperature (160° C. to 200° C.), the interior temperature is held for 30 minutes to 2 hours. The granulated and/or powderized Wakkanai diatom shale is sterilized with dry heat. The heating temperature and the heating time are adjusted based on the amount of moisture in the Wakkanai diatom shale to be dried.

To efficiently dry the Wakkanai diatom shale, drying the Wakkanai diatom shale while stirring can be considered. However, to do so, a special structure is required. For example, the Wakkanai diatom shale is required to be dried inside the electric drying furnace that has a sealed structure and a stirring apparatus that has a heat-resistant structure is required to be provided.

In addition, while the amount of environmental improvement material for livestock to be used differs depending on the scale of the cattle farm, several hundred kilograms of Wakkanai diatom shale may be required. Therefore, cost is required to be low. Consequently, it is preferable that an electric drying furnace that is already installed be used.

To eliminate bacteria that is attached to or present inside or outside of the granulated and/or powderized Wakkanai diatom shale that has not been subjected to a sterilization treatment, the sterilization treatment is performed using a dry-heat sterilizer. The interior and exterior of the granulated and/or powderized Wakkanai diatom shale are made to be in an aseptic state.

To test the antibacterial effect of the Wakkanai diatom shale that is in this aseptic state, the granulated and/or powderized Wakkanai diatom shale that is in the aseptic state was separated into containers. A test bacteria solution for growing E. coli and staphylococcus aureus, which are typical examples of general bacteria, was added to each container and mixed with the Wakkanai diatom shale. Changes in the state of each bacteria occurring over time were observed.

The test was conducted at Japan Food Research Laboratories. The test bacteria was obtained by being cultured for 18 to 24 hours at 35° C.±1° C., using a nutrient agar medium. Subsequently, the test bacteria was suspended in a nutrient broth medium and adjusted such that the bacteria count became 10³ to 10⁴/mL. Regarding testing operation, a test sample was obtained by adding 4 mL of the test bacteria solution to 4 g of a specimen and mixing. The test sample was held at 25° C.±1° C. After 6 hours, 24 hours, and 48 hours, the test sample was immediately diluted tenfold with a soybean-casein digest broth with lecithin and polysorbate (SCDLP medium), and the number of viable bacteria in the test sample was counted using a medium for determining bacteria count. A preliminary test confirmed that, as a result of a test sample being diluted tenfold with the SCDLP medium, the viable bacteria count can be determined without influence from the specimen.

A test was similarly conducted using a test bacteria solution to which the specimen has not been added, as a control sample. The viable bacteria count was determined at the start of the test, as well. Test results are shown in Table 1.

TABLE 1
Wakkanai diatom shale subjected to
dry-heat sterilization treatment and test bacteria for growth

| | | Viable bacteria count (/g) | | | |
|---|---|---|---|---|---|
| | | | After 6 | After 24 | After 48 |
| Test bacteria | Specimen | Start of test | hours | hours | hours |
| E. coli | Wakkanai | | | | |
| | diatom shale | | | | |
| | Not added | | | | |
| Staphylococcus | Wakkanai | | | | |
| aureus | diatom shale | | | | |
| | Not added | | | | |

(1) Test bacteria solution to which a specimen has not been added.
(2) <10: Test bacteria not detected.

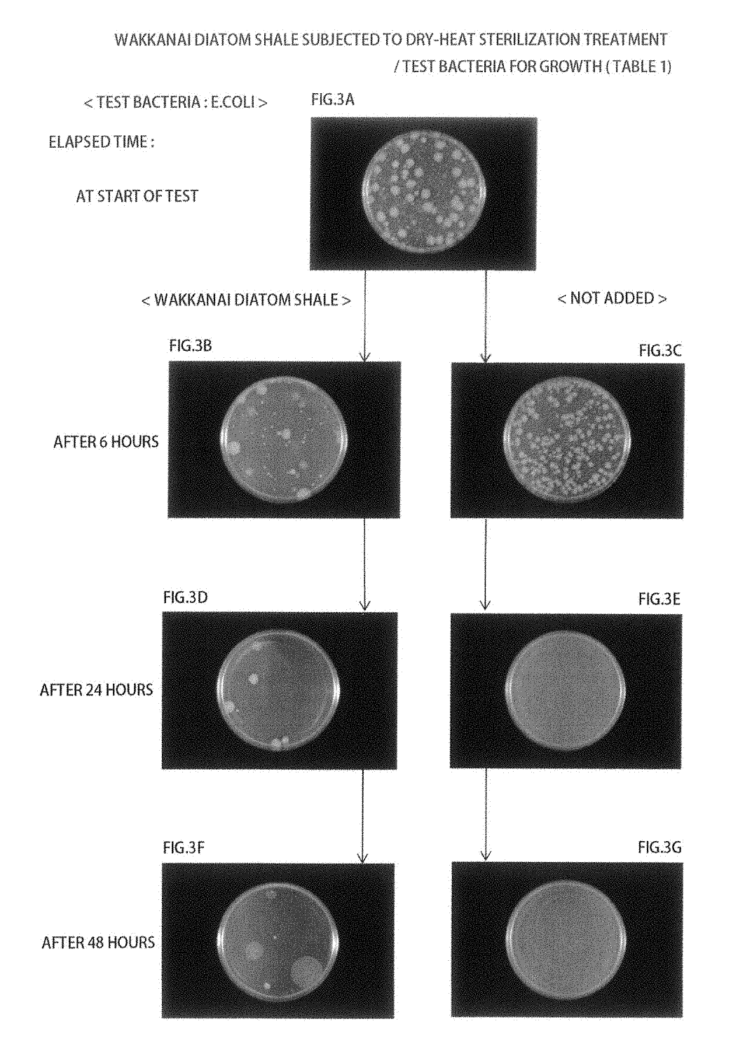

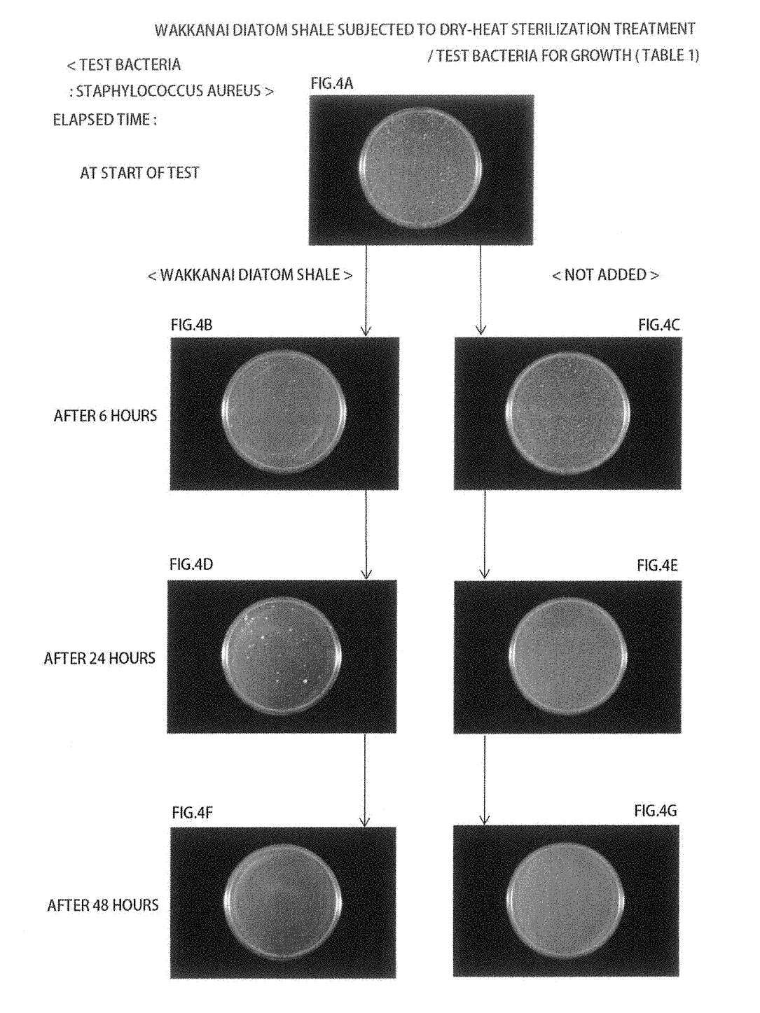

As indicated by the test results in Table 1, E. coli and staphylococcus aureus that are the test bacteria for growth added to and mixed with the diatom shale that has been subjected to a sterilization treatment continued to decrease with the elapse of time. After 48 hours, a substantially sterilized state, that is, an aseptic state was reached (FIG. 3A to FIG. 3G and FIG. 4A to FIG. 4G show plates for determining the viable bacteria count after each amount of time).

Regarding E. coli that has been added to and mixed with the sterilized diatom shale, the count was 6.6×10³ at the time E. coli was added (FIG. 3A). The count decreased to 10.3%, that is, 6.8×10² after 6 hours (FIG. 3B). A substantially sterilized state with a count of 40 to 50 was reached after 24 to 48 hours (FIGS. 3D and 3F).

Regarding staphylococcus aureus that has been similarly added to and mixed with the sterilized diatom shale, the count was 1.0×10⁴ at the time staphylococcus aureus was added (FIG. 4A). The count decreased to 8.5%, that is, 8.5×10² after 6 hours (FIG. 4B). The count decreased to 3.6%, that is, 3.6×10² after 24 hours (FIG. 4D). A sterilized state with a count of less than 10 was reached after 48 hours (test bacteria not detected; FIG. 4F).

Meanwhile, regarding the containers (not added) in which the Wakkanai diatom shale has not been added and that contain only the test bacteria for growth, the respective bacteria continued to increase with the elapse of time. After 48 hours, E. coli drastically increased by 6.06×10⁵-fold to a count of 4.0×10⁹ (FIG. 3G), and staphylococcus aureus by 2.1×10⁵-fold to a count of 2.1×10⁹ (FIG. 4G).

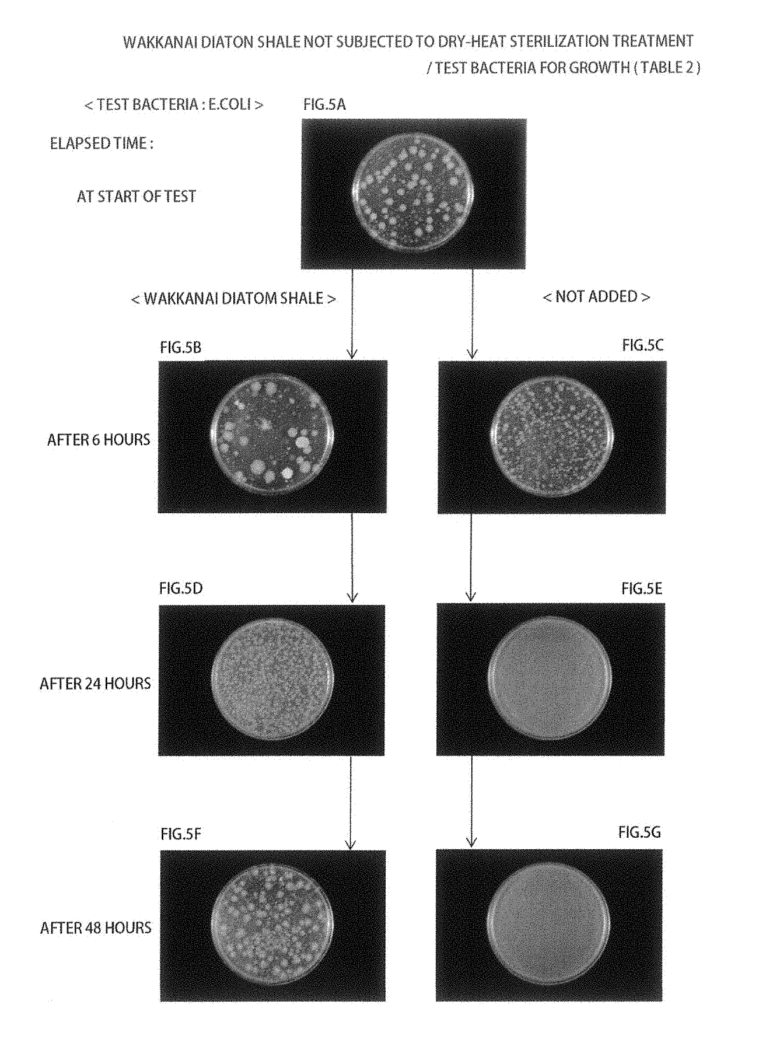

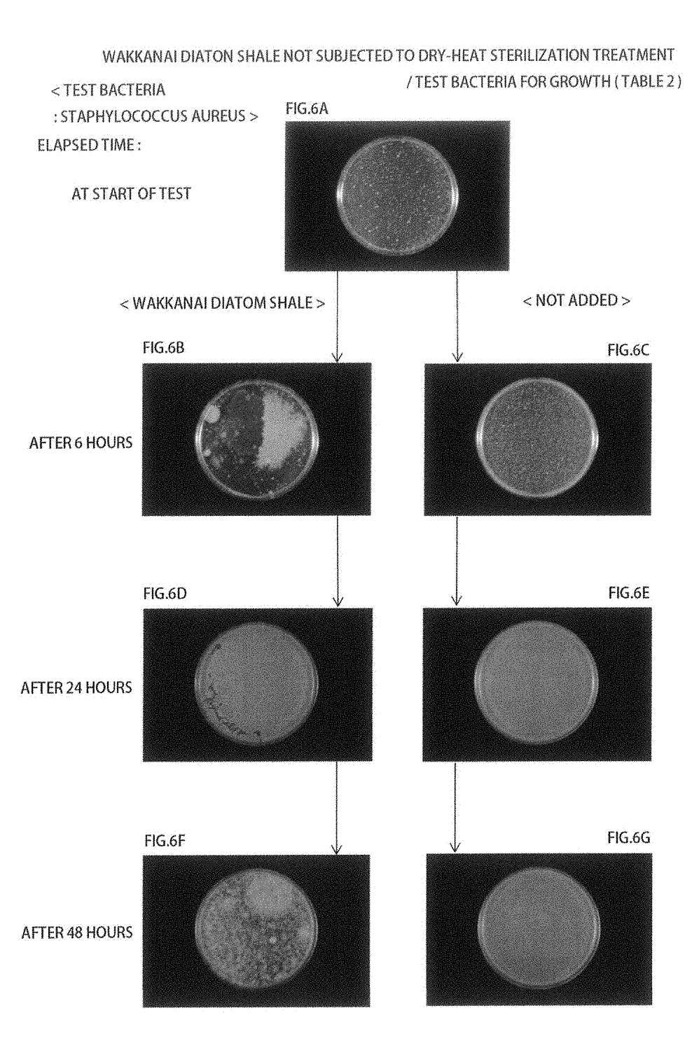

Next, results of a similar test conducted on Wakkanai diatom shale in a natural state that has not been subjected to the dry-heat sterilization treatment is shown in Table 2 (FIG. 5A to FIG. 5G and FIG. 6A to FIG. 6G show plates for determining the viable bacteria count after each amount of time).

TABLE 2
Natural-state Wakkanai diatom shale not subjected
to dry-heat sterilization treatment and test bacteria for growth

| | | Viable bacteria count (/g) | | | |
|---|---|---|---|---|---|
| | | | After 6 | After 24 | After 48 |
| Test bacteria | Specimen | Start of test | hours | hours | hours |
| E. coli | Wakkanai | | | | |
| | diatom shale | | | | |
| | (natural | | | | |
| | state) | | | | |
| | Not added | | | | |
| Staphylococcus | Wakkanai | | | | |
| aureus | diatom shale | | | | |
| | (natural | | | | |
| | state) | | | | |
| | Not added | | | | |

(1) Contains bacteria other than the test bacteria (numbers in the table indicate the test bacteria count).

The test bacteria for growth added to natural-state Wakkanai diatom shale that has not been subjected to the dry-heat sterilization treatment each showed slight decrease after 6 hours (FIG. 5B and FIG. 6B). However, the test bacteria subsequently continued to increase. After 48 hours, E. coli increased by 6.17×10²-fold to a count of 3.7×10⁶ (FIG. 5F), and staphylococcus aureus by 6.02×10²-fold to a count of 5.3×10⁶ (FIG. 6F).

Regarding the containers (not added) in which the Wakkanai diatom shale has not been added and that contain only the test bacteria, the respective bacteria continued to increase with the elapse of time. After 48 hours, E. coli drastically increased by 7.0×10⁵-fold to a count of 4.5×10⁹ (FIG. 5G), and staphylococcus aureus by 1.0×10⁵-fold to a count of 8.8×10⁸ (FIG. 6G).

The test conducted on the Wakkanai diatom shale that has been subjected to a sterilization treatment and the test conducted on the Wakkanai diatom shale that has not been subjected to a sterilization treatment were conducted at differing dates. Therefore, slight differences are present in the numeric values of the bacteria.

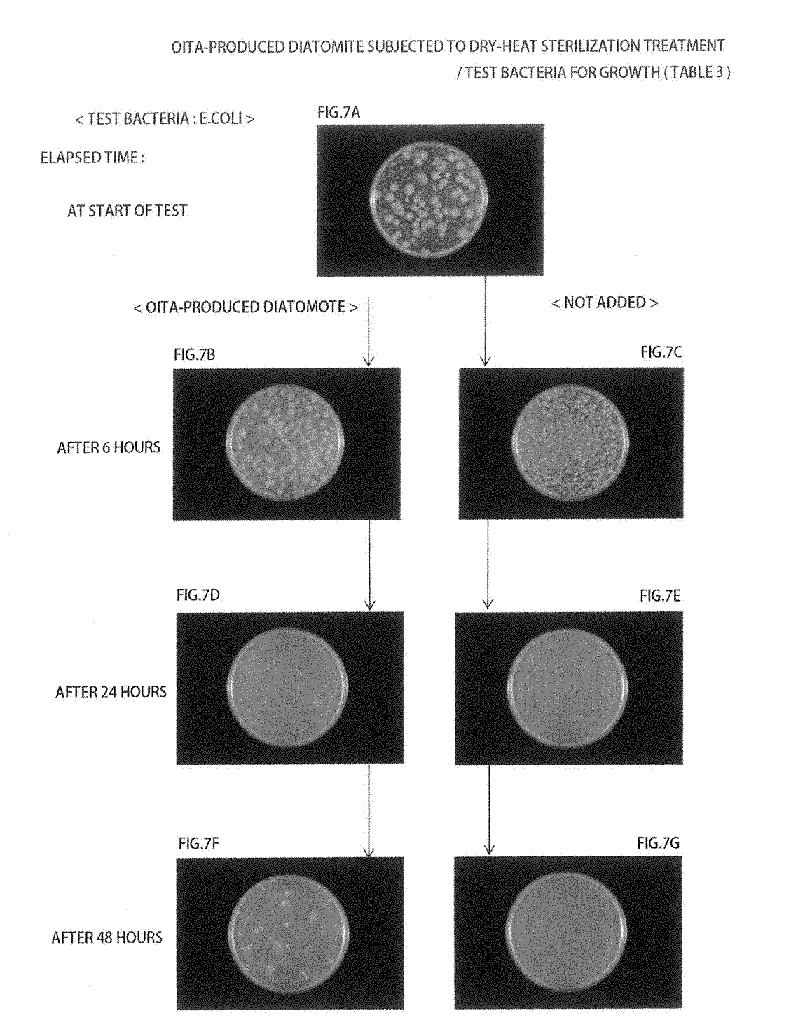

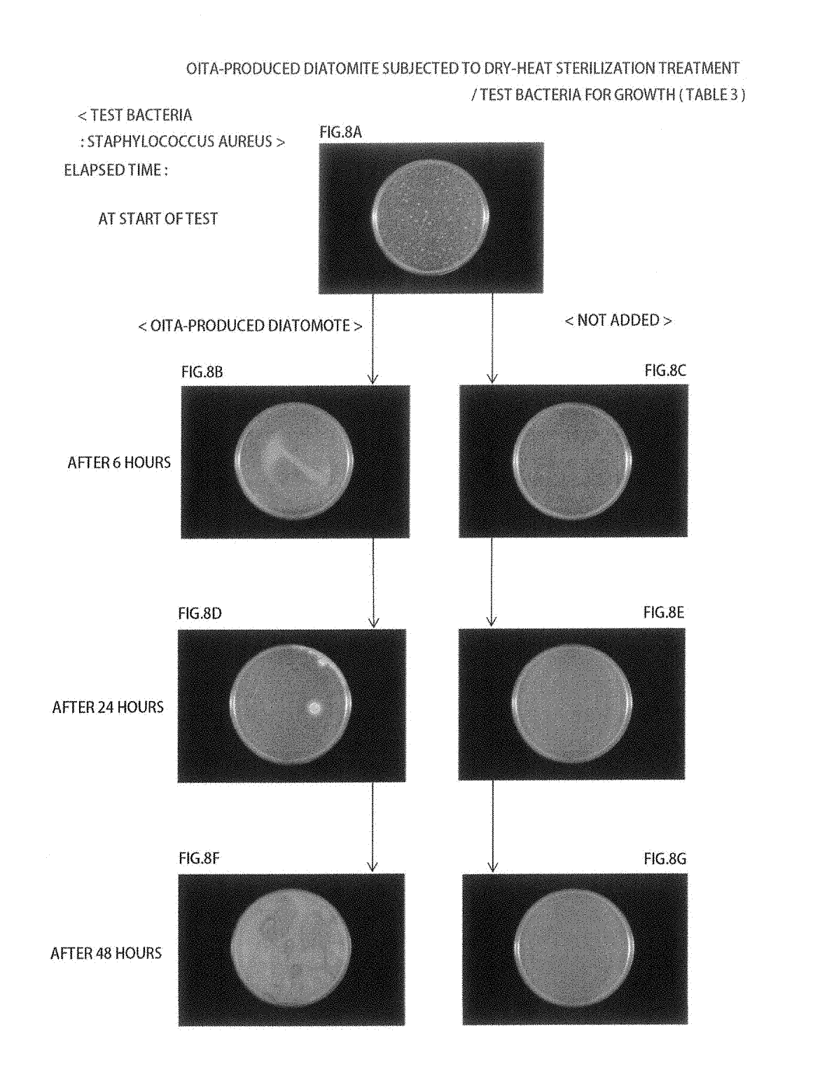

Next, results of a similar test conducted on diatomite produced domestically, that is, Oita-produced diatomite that has been subjected to the dry-heat sterilization treatment is shown in Table 3 (FIG. 7A to FIG. 7G and FIG. 8A to FIG. 8G show plates for determining the viable bacteria count after each amount of time).

TABLE 3
Oita-produced diatomite subjected to dry-heat
sterilization treatment and test bacteria for growth

| | | Viable bacteria count (/g) | | | |
|---|---|---|---|---|---|
| | | Start of | After 6 | After 24 | After 48 |
| Test bacteria | Specimen | test | hours | hours | hours |
| E. coli | Oita- | | | | |
| | produced | | | | |
| | diatomite | | | | |
| | Not added | | | | |
| Staphylococcus | Oita- | | | | |
| aureus | produced | | | | |
| | diatomite | | | | |
| | Not added | | | | |

(1) Contains bacteria other than the test bacteria (numbers in the table indicate the test bacteria count).

Each test bacteria for growth added to the Oita-produced diatomite that has been subjected to a sterilization treatment continued to increase with the elapse of time. After 48 hours, E. coli increased by 4.59×10⁵-fold to a count of 3.4×10⁹, and staphylococcus aureus by 1.08×10⁵-fold to a count of 9.4×10⁸.

Regarding the containers (not added) that contain only the test bacteria, the respective bacteria continued to increase with the elapse of time. After 48 hours, E. coli drastically increased by 6.8×10⁵-fold to a count of 4.5×10⁹ (FIG. 7F), and staphylococcus aureus by 2.76×10⁵-fold to a count of 2.4×10⁹ (FIG. 8F).

The test conducted on the Oita-produced diatomite that has been subjected to a sterilization treatment and the tests conducted on the Wakkanai diatom shale shown in Table 1 and Table 2 were conducted at differing dates. Therefore, slight differences are present in the numeric values of the bacteria.

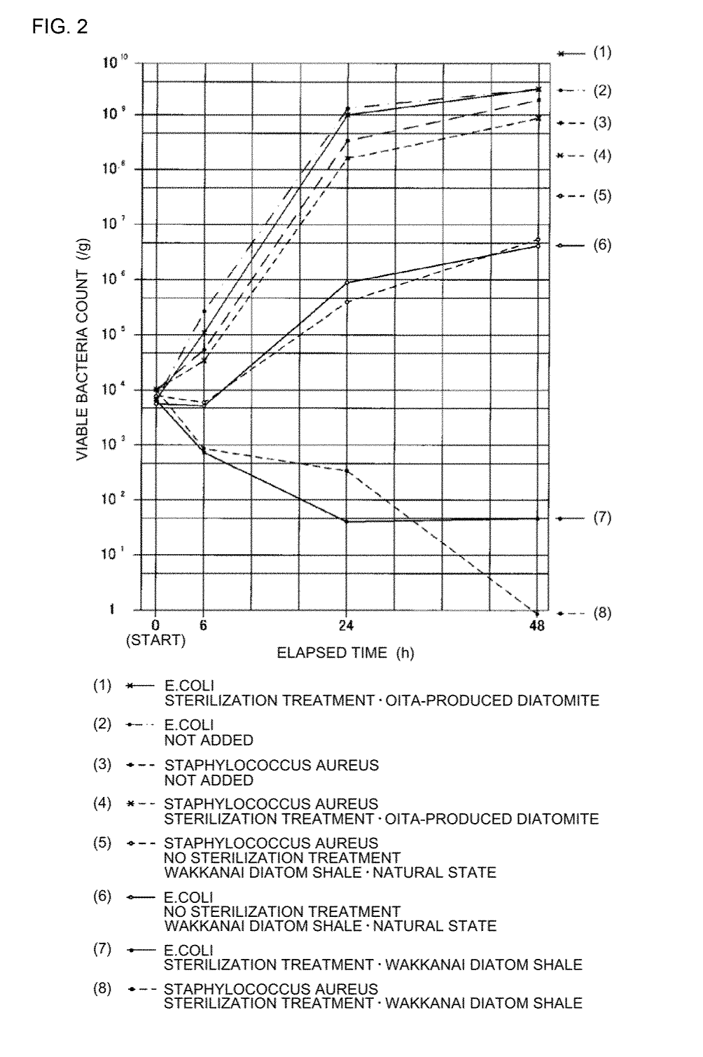

The test results are compiled and shown in FIG. 2.

In FIG. 2, a vertical axis indicates the viable bacteria count of the test bacteria for growth in logarithmic units. A horizontal axis indicates time from the start of the test until the viable bacteria count is taken.

As is clear from FIG. 2, in the Wakkanai diatom shale that has been subjected to the dry-heat sterilization treatment, the viable bacteria count continues to decrease with the elapse of time, and a state that can analytically be considered aseptic is reached after 48 hours. Meanwhile, in the Wakkanai diatom shale that has not been subjected to the dry-heat sterilization treatment, in a manner similar to that in the Oita-produced diatomite that has been subjected to the dry-heat sterilization treatment, the viable bacteria count continues to increase with the elapse of time. The difference between the results is apparent.

Next, test results for other bacteria and viruses will be described. In a manner similar to the above-described tests for E. coli and staphylococcus aureus, a sterilization treatment using a dry-heat sterilizer was performed to eliminate bacteria attached to or present in the interior and exterior of granulated and/or powderized Wakkanai diatom shale that has not been subjected to a sterilization treatment. The interior and exterior of the granulated and/or powderized Wakkanai diatom shale was made to be in an aseptic state.

To test the antibacterial effect of the Wakkanai diatom shale that is in this aseptic state, the granulated and/or powderized Wakkanai diatom shale that is in the aseptic state was separated into containers. A test bacteria solution for growing salmonella, which is a typical example of general bacteria, was added to each container and mixed with the Wakkanai diatom shale. Changes in the state of the bacteria occurring over time was observed.

The test was conducted at Japan Food Research Laboratories. The test bacteria was obtained by being cultured for 18 to 24 hours at 35° C.±1° C., using a nutrient agar medium. Subsequently, the test bacteria was suspended in a nutrient broth medium and adjusted such that the bacteria count became 10³ to 10⁴/mL. Regarding testing operation, a test sample was obtained by adding 4 mL of the test bacteria solution to 4 g of a specimen and mixing. The test sample was held at 25° C.±1° C. After 6 hours, 24 hours, and 48 hours, the test sample was immediately diluted tenfold with an SCDLP medium, and the number of viable bacteria in the test sample was counted using a medium for determining bacteria count. A preliminary test confirmed that, as a result of a test sample being diluted tenfold with the SCDLP medium, the viable bacteria count can be determined without influence from the specimen.

A test was similarly conducted using a test bacteria solution to which the specimen has not been added, as a control sample. The viable bacteria count was determined at the start of the test, as well. Test results are shown in Table 4.

TABLE 4

| | | Viable bacteria count (/g) | | | |
|---|---|---|---|---|---|
| | | Start of | After 6 | After 24 | After 48 |
| Test bacteria | Subject | test | hours | hours | hours |
| Salmonella | Specimen | | | | |
| | Control | | | | |

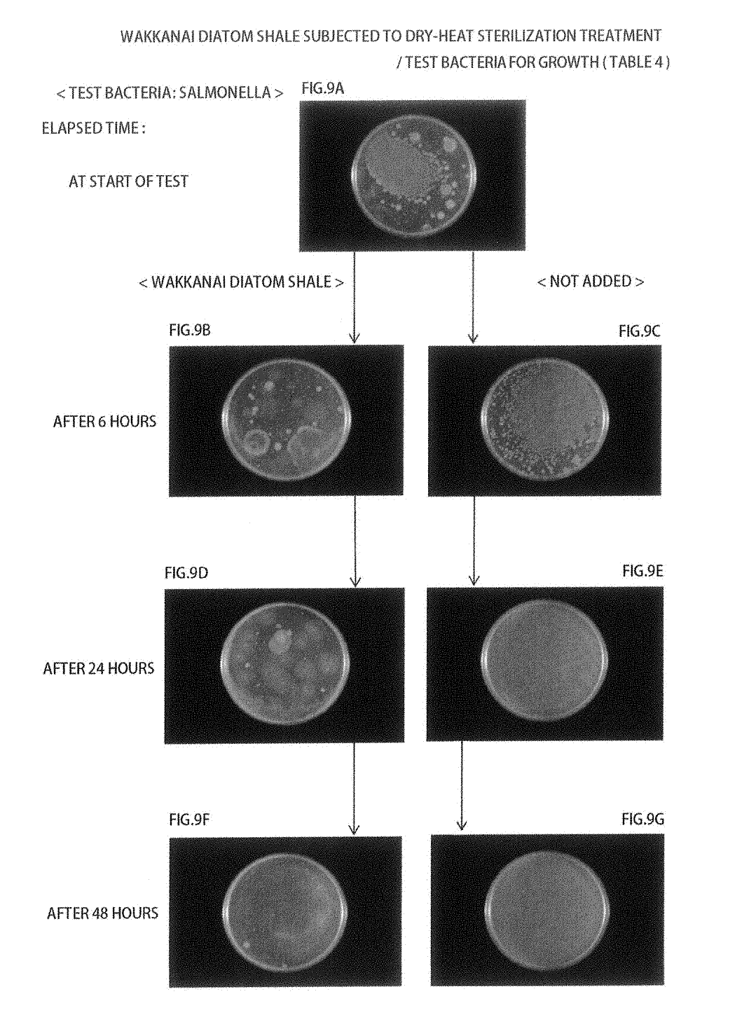

As indicated by the test results in Table 4, salmonella added to and mixed with the Wakkanai diatom shale that has been subjected to a sterilization treatment continued to decrease with the elapse of time. After 48 hours, the count decreased to 3.4% (FIG. 9A to FIG. 9G show plates for determining the viable bacteria count after each amount of time).

Regarding salmonella that has been added to and mixed with the sterilized diatom shale, the count was 3.8×10³ at the time salmonella was added (FIG. 9A). The count decreased to 1.4×10³ after 6 hours (FIG. 9B), and to 6.8×10² after 24 hours (FIG. 9D). The count decreased to 3.4%, that is, 1.3×10² after 48 hours (FIG. 9F), and a substantially sterilized state was reached.

Meanwhile, regarding the container (not added) in which the Wakkanai diatom shale has not been added and that contains only the test bacteria for growth, salmonella continued to increase with the elapsed of time. The count was 3.8×10³ at the time salmonella was added (FIG. 9A). The count drastically increased to 8.0×10⁴ after 6 hours (FIG. 9C), to 1.3×10⁹ after 24 hours (FIG. 9E), and to 2.7×10⁹ after 48 hours (FIG. 9G).

Because there are slight differences in various conditions, differences also occur between the numeric values in Table 4 and the numeric values of the test results in Table 1 to Table 3.

Next, a virus deactivation test will be described. In a manner similar to the above-described tests for E. coli and staphylococcus aureus, a sterilization treatment using a dry-heat sterilizer was performed to eliminate bacteria and deactivate viruses attached to or present in the interior and exterior of granulated and/or powderized Wakkanai diatom shale that has not been subjected to a sterilization treatment. The interior and exterior of the granulated and/or powderized Wakkanai diatom shale was made to be in an aseptic state.

To test the virus deactivation effect of the Wakkanai diatom shale that is in this aseptic state, the granulated and/or powderized Wakkanai diatom shale that is in the aseptic state was separated into containers. A test sample was obtained by a virus suspension (05 mL) of feline calicivirus, which is widely used as a surrogate virus for norovirus that cannot be cell-cultured, being added to and mixed with one of the specimens (0.5 g). The virus suspension was obtained by a virus culture solution after cell cultivation being subjected to centrifugal separation, and the resultant supernatant being diluted tenfold with purified water. CRFK cells were used.

The test was conducted at Japan Food Research Laboratories. Regarding testing operation, the test sample was stored at room temperature. After 6 hours and 24 hours, the test sample was immediately diluted tenfold with a cell maintenance medium (Eagle's minimal essential medium [MEM] containing 2% fetal bovine serum). The virus infectivity titer of the test sample was measured. A preliminary test confirmed that, as a result of a test sample being diluted tenfold with the cell maintenance medium, the virus infectivity titer can be determined without influence from the specimen. An Eagle's MEM containing 10% fetal bovine serum was used as a cell growth medium.

A test was similarly conducted using a virus suspension of influenza virus to which the specimen has not been added, as a control sample. At the start of the test, and after 6 hours and 24 hours, the test sample was immediately diluted tenfold with the cell maintenance medium, and the virus infectivity titer of the test sample was measured. Test results are shown in Table 5.

Next, an influenza virus deactivation effect will be described. First, a sterilization treatment using a dry-heat sterilizer was performed to eliminate bacteria and deactivate viruses attached to or present in the interior and exterior of granulated and/or powderized Wakkanai diatom shale. The interior and exterior of the granulated and/or powderized Wakkanai diatom shale was made to be in an aseptic state.

To test the virus deactivation effect of the Wakkanai diatom shale that is in this aseptic state, the granulated and/or powderized Wakkanai diatom shale that is in the aseptic state was separated into containers. A test sample was obtained by a virus suspension (05 mL) of influenza virus being added to and mixed with one of the specimens (0.5 g). The virus suspension was obtained by a virus culture solution after cell cultivation being subjected to centrifugal separation, and the resultant supernatant being diluted tenfold with purified water. In addition, MDCK (NBL-2) (ATCC CCL-34) cells were used.

The test was conducted at Japan Food Research Laboratories. Regarding testing operation, the test sample was stored at room temperature. After 6 hours and 24 hours, the test sample was immediately diluted tenfold with a cell maintenance medium (100 mL of MEM, 9.8 mL of 10% NaHCO₃ and L-glutamine [30 g/L], 30 mL of 100× vitamin solution for MEM, 20 mL of 10% albumin, and 20 mL of 0.25% trypsin). The virus infectivity titer of the test sample was measured. A preliminary test confirmed that, as a result of a test sample being diluted tenfold with the cell maintenance medium, the virus infectivity titer can be determined without influence from the specimen.

A test was similarly conducted using a virus suspension of influenza virus to which the specimen has not been added, as a control sample. At the start of the test, and after 6 hours and 24 hours, the test sample was immediately diluted tenfold with the cell maintenance medium, and the virus infectivity titer of the test sample was measured. Test results are shown in Table 5.

TABLE 5

| | | log TCID₅₀/g | | | |
|---|---|---|---|---|---|
| | | Start of | After 6 | After 24 | After 48 |
| Test virus | Subject | test | hours | hours | hours |
| Feline calicivirus | Specimen | | | | |
| | Control | | | | |
| Influenza virus | Specimen | | | | |
| | Control | | | | |

TCID50: Median tissue culture infectious dose; 50% tissue culture infectious dose.
<1.5: Not detected.
*: Surrogate virus for norovirus

In this way, the virus deactivation effect of Wakkanai diatom shale that has been subjected to a sterilization treatment is a new function that has been added for the first time as a result of the Wakkanai diatom shale being subjected to a sterilization treatment. It is clear that the function of the Wakkanai diatom shale that has been subjected to a sterilization treatment to deactivate viruses is a unique function.

An environmental improvement material that disinfects or sterilizes general bacteria including E. coli and staphylococcus aureus through application of the function of the Wakkanai diatom shale that has been subjected to a sterilization treatment to disinfect or sterilize E. coli and staphylococcus aureus is described below.

### Example 1

An example in which granulated and/or powderized Wakkanai diatom shale is subjected to a sterilization treatment and used as an environmental improvement material for livestock will be described.

To improve the safety of livestock, individual cattle farms are taking sanitation measures, such as sterilization of entrances to the farms and areas surrounding livestock barns, as well as sterilization of the interior of livestock barns. In particular, sanitation management of the interior of livestock barns is an important element of maintaining the health of livestock.

As a typical example of sanitation management for livestock, an example in which Wakkanai diatom shale that has been subjected to a sterilization treatment is used as an environmental improvement material for the interior and exterior of a cattle barn for dairy cattle and beef cattle will be described.

To improve the safety of food products, safety and sanitation management inside and outside cattle barns where dairy cattle and beef cattle are raised is important. The interior and exterior of the cattle barn are required to be kept clean and comfortable to maintain the health of cattle. However, the biggest cause of deterioration in the environment is feces and urine, which are daily excretions. That is, feces and urine produce ammonia gas. In addition, Feces and urine contain food poisoning bacteria, such as E. coli and staphylococcus aureus, that causes food poisoning.

A stall barn, which is common, is structured such that stalls are aligned in a length direction of the cattle barn. Feeding troughs are provided on one side of the stall and a manure reservoir is provided on the other side.

The cattle stall is required to be a comfortable environment in which cattle that has consumed feed can unhurriedly lie down and ruminate. In most cattle stalls, bedding, such as hay, is spread over a concrete floor that can be easily washed.

When the amount of bedding is small or when the bedding is infrequently replaced, a sludge-like state is created by the feces and urine from the cattle, causing growth of E. coli, staphylococcus aureus, and the like. In addition, feces attached to the cattle is scattered by movement of the cattle, resulting in E. coli and staphylococcus aureus present in the feces being scattered. Furthermore, contamination from feces attached to the hindquarters of the cattle spread from the udder to the teats, causing bacteria that causes garget to enter from the teats.

The cattle is ordinarily fed twice a day, in the morning and in the evening. In addition to the feeding times, the cattle continues to consume feed that remains in the feeding trough. When the cattle consumes feed and drinks water, the cattle excretes feces and urine. The feces and urine that are excretions are mainly collected in the manure reservoir. However, at the same time, the feces and urine may be excreted or sprayed onto the bedding in cattle stall, thereby contaminating the bedding.

Therefore, to maintain sanitation inside and outside the cattle barn, the interior and exterior of the cattle barn is required to be kept sanitary, such as by the feces and urine in the manure reservoir being frequently removed, the bedding in the stall that has been contaminated with feces and urine being frequently replaced, and aisles and surrounding areas being cleaned.

Conventionally, when an entire cattle barn is to be disinfected, feces, urine, and contaminated beddings are removed. Subsequently, an antiseptic agent, such as invert soap or slaked lime, is dispersed throughout the cattle barn, mainly on the manure reservoir, the stalls, and the aisles. The disinfection operation is a large-scale operation because the dispersion operation involves evacuating the cattle outside of the cattle barn before the operation, wearing protective gear, such as goggles and masks, during the operation, and the like. In addition, some antiseptic agents are harmful to humans and cattle, and need to be handled with care. In particular, slaked lime may cause inflammation of the udder in cows. Therefore, care is required to be taken to sweep out the slaked lime, lay a thick layer of bedding, or the like before the cattle is allowed into the barn.

To maintain a comfortable breeding environment for cattle, bedding contaminated by feces and urine is required to be frequently replaced. The stalls, manure reservoirs, and aisles are required to be frequently cleaned. Dispersing an antiseptic agent each time these actions are taken is extremely laborious.

Therefore, to maintain and improve daily cleanliness, Wakkanai diatom shale, which is a natural, low-cost material that is harmless to humans and animals, can be easily dispersed, is excellent in absorbing moisture and odors, and has an effect of retaining and suppressing bacteria, is used as an environmental improvement material that suppresses bacteria in the stalls, bedding, manure reservoirs, and aisles.

As a result of Wakkanai diatom shale that has been pulverized into granules and/or powder being dispersed on the stalls, bedding, manure reservoirs, and aisles, moisture and odors can be absorbed. At the same time, general bacteria, such as E. coli and staphylococcus aureus, contained in feces and urine can be retained and suppressed.

However, the Wakkanai diatom shale itself only provides the suppressing effect of preventing growth of bacteria, and cannot disinfect or sterilize bacteria.

Therefore, the disinfecting operation for the interior and exterior of the cattle barn performed from the perspective of safety and sanitation management is required to be performed at the same frequency as in the past.

Meanwhile, the environmental improvement material of the present invention that additionally disinfects or sterilizes general bacteria including E. coli and staphylococcus aureus as a result of the Wakkanai diatom shale being subjected to a sterilization treatment provides an revolutionary function in that general bacteria including E. coli, staphylococcus aureus, and the like that is present in the dispersion location is disinfected or sterilized.

As a result of the granulated and/or powderized Wakkanai diatom shale that has been subjected to a sterilization treatment being dispersed on the stalls, beddings, manure reservoirs, and aisles as an environmental improvement material, general bacteria including E. coli, staphylococcus aureus, and the like that are contained in feces and urine can be disinfected or sterilized.

Bacteria continues to grow when moisture and nutrients are present. Therefore, as a result of the granulated and/or powderized environmental improvement material composed of Wakkanai diatom shale that has been subjected to a sterilization treatment being dispersed on the stalls, aisles, and manure reservoir after washing with water, remaining bacteria can be disinfected or sterilized, and moisture and odors can be absorbed.

In addition, when the bedding and aisles become contaminated before cleaning, the spread and growth of bacteria progresses. Therefore, anti-bacterial effects can be improved by the environmental improvement material being dispersed as appropriate.

Even should feces and urine become attached to clothing during the cleaning operation, the attached bacteria can be eliminated by the clothing after the cleaning operation being wrapped in the environmental improvement material composed of granulated and/or powderized Wakkanai diatom shale that has been subjected to a sterilization treatment. The environmental improvement material can contribute to preventing the spread of bacteria.

The feces, urine, contaminated bedding, and the like that are collected during the cleaning are discharged into a composting field and used as fertilizer. The feces, urine, and the like that are piled in the composting field cause growth of general bacteria including E. coli, staphylococcus aureus, and the like present in the feces and urine. Fermentation occurs and a foul odor is produced. Therefore, as a result of the environmental improvement material composed of granulated and/or powderized Wakkanai diatom shale that has been subjected to a sterilization treatment being dispersed at the time of discharge or during piling, or being mixed into or spread over the discharged waste, disinfection and sterilization can be performed in the composting field. The foul odor of basic odor, of which a typical example is ammonia odor, can also be eliminated.

As a result, daily cleanliness can be improved, the interior and exterior of the cattle barn can be kept clean and comfortable, and a significant contribution can be made to maintaining the health of cattle. In addition, as a result, the frequency of the disinfection operation for the interior and exterior of the cattle barn can be significantly reduced. Contributions can be made to improving the work environment for workers and reducing cost.

### Example 2

An example in which granulated and/or powderized Wakkanai diatom shale is subjected to a sterilization treatment and used as an environmental improvement material that serves as a preservative for food products or is used in food processing facilities is described.

A fundamental of preserved food is the importance of preventing food from becoming spoiled. A major factor in food becoming spoiled is spoilage caused by microorganisms such as bacteria and mold. To eliminate such microorganisms that cause spoilage, the environmental improvement material of the present invention that additionally disinfects or sterilizes general bacteria including E. coli and staphylococcus aureus as a result of the Wakkanai diatom shale being subjected to a sterilization treatment can be used.

As a result of a food product being covered by the environmental improvement product serving as a preservative and composed of granulated and/or powderized Wakkanai diatom shale that has been subjected to a sterilization treatment, bacteria attached to the food product can be disinfected or sterilized, and bacteria that infiltrates from outside can also be eliminated. As a result, the food product can be stored over a long period without spoiling.

In addition, as a result of the environmental improvement material serving as a preservative being housed in a container and placed inside a storage room for food products, bacteria floating in the air inside the room can attach to the preservative. The preservative can disinfect or sterilize the attached bacteria, and the food product can be stored over a longer period without spoiling.

The environmental improvement material composed of granulated and/or powderized Wakkanai diatom shale that has been subjected to a sterilization treatment may be used as a preservative by being solidified such as not to lose the functions provided by the Wakkanai diatom shale that has been subjected to a sterilization treatment.

Furthermore, in addition to usage of the environmental improvement material by itself, the range of application can be widened by the granulated and/or powderized Wakkanai diatom shale that has been subjected to a sterilization treatment being applied to a sheet material such as film or paper, or impregnating a sheet material such as cloth, and a target object to be sterilized being wrapped with the sheet material.

In addition, bacteria does not grow in a low-temperature state, such as in a refrigerated warehouse or a refrigerator, and spoilage of food products is suppressed. However, the bacteria attached to the food product and the bacteria inside the refrigerator do not die. Therefore, as a result of the environmental improvement material serving as a preservative (including a solidified preservative) and composed of granulated and/or powderized Wakkanai diatom shale that has been subjected to a sterilization treatment being placed inside the refrigerated warehouse or refrigerator, bacteria floating in the air inside the warehouse or refrigerator that attaches to the preservative can be disinfected or sterilized. The refrigerated food product can be stored over a long period. At the same time, should the food product being stored in low-temperature or refrigerated conditions be covered by the environmental improvement material, the disinfecting or sterilizing effect can be better achieved.

Meanwhile, to ensure safety of food products, sanitation management in food processing facilities is essential. To suppress and eliminate bacteria that floats in the air inside a food processing facility, and to eliminate unpleasant odors such as basic odors, of which a typical example is ammonia odor, the environmental improvement material composed of granulated and/or powderized Wakkanai diatom shale or solidified Wakkanai diatom shale that has been subjected to a sterilization treatment can be used in filters for purifying the air inside the facility, as a material for interior walls, and the like. In addition to such single usages, cloths, films, paper, and the like to which the environmental improvement material is applied, attached, or impregnated can also be used.

In addition, as a result of the environmental improvement material composed of granulated and/or powderized Wakkanai diatom shale that has been subjected to a sterilization treatment being dispersed on a floor or the like during cleaning inside a facility, the bacteria attached to the floor and the like can be suppressed or eliminated. Basic odors, of which a typical example is ammonia odor, can be eliminated.

In addition, as a result of the environmental improvement material composed of granulated and/or powderized Wakkanai diatom shale that has been subjected to a sterilization treatment being used to cover clothing worn by workers and the like to which bacteria and odors are attached, the bacteria attached to the clothing and the like can be suppressed or eliminated. Basic odors, of which a typical example is ammonia odor, can be eliminated. In addition to such single usages, cloths, films, paper, and the like to which the environmental improvement material is applied, attached, or impregnated can also be used.

Furthermore, the environmental improvement material of the present invention achieves similar effects even in food storage facilities. Moreover, the environmental improvement material of the present invention can be dispersed in the surrounding area of a facility, and can also achieve the effects in places where food products tend to spoil as a result of development of microorganisms, such as bacteria and mold, such as in dumping grounds for food products and garbage disposal sites.

Furthermore, the environmental improvement material of the present invention can also be used as an antibacterial or antiseptic material for medical use.

Medical facilities, such as hospitals and elderly-care facilities, take measures to reduce and eliminate bacteria and viruses present in the air inside the facility, as well as unpleasant odors.

As an antibacterial or antiseptic material for air-conditioning systems in medical facilities, the environmental improvement material composed of granulated and/or powderized Wakkanai diatom shale that has been subjected to a sterilization treatment can be used as a filter that purifies the air inside a facility, thereby suppressing or eliminating bacteria and viruses in the air. At the same time, the environmental improvement material of the present invention can eliminate basic odors, of which a typical example is ammonia odor.

As a result of the environmental improvement material composed of granulated and/or powderized Wakkanai diatom shale that has been subjected to a sterilization treatment being used as an interior material in patient rooms, hallways, lobbies, and the like, bacteria and viruses inside a facility can be suppressed or eliminated. At the same time, basic odors, of which a typical example is ammonia odor, can be eliminated. In this case, in addition to the environmental improvement material composed of granulated and/or powderized Wakkanai diatom shale, or Wakkanai diatom shale as a fixation material, that has been subjected to a sterilization treatment being used by itself, cloths, films, paper, and the like to which the Wakkanai diatom shale is applied, attached, or impregnated can also be used as the environmental improvement material.

In addition, as a result of granulated and/or powderized Wakkanai diatom shale that has been subjected to a sterilization treatment being applied to surgical masks and surgical wear, antibacterial and antiseptic properties can be enhanced.

Furthermore, the environmental improvement material of the present invention can be used as an antibacterial or antiseptic material for housing. The granulated and/or powderized Wakkanai diatom shale that has been subjected to a sterilization treatment can be used to maintain and improve a comfortable living environment.

Still further, as a result of the environmental improvement material composed of granulated and/or powderized Wakkanai diatom shale that has been subjected to a sterilization treatment being used as a filter in indoor air-conditioners and air purifiers, indoor air can be purified by bacteria being suppressed or eliminated. At the same time, basic odors, of which a typical example is ammonia odor, can be eliminated.

In addition, as a result of the environmental improvement material composed of granulated and/or powderized Wakkanai diatom shale that has been subjected to a sterilization treatment being placed in spaces where bacteria tends to develop, such as in kitchens, garbage disposal sites, and pet areas, the development of bacteria can be suppressed and bacteria can be eliminated.

Furthermore, the environmental improvement material of the present invention can be used as an antibacterial or antiseptic material for garbage collection.

Garbage collection is a necessity in maintaining the functions of life in towns and cities. Kitchen waste easily spoils. In particular, bacteria easily develops in accumulated kitchen waste. The odor is also extremely strong.

As a result of the environmental improvement material composed of granulated and/or powderized Wakkanai diatom shale that has been subjected to a sterilization treatment being dispersed on the floor of garbage disposal sites, in the interior of baggage compartments in garbage collection vehicles, and inside waste collection plants, the development of bacteria can be suppressed and bacteria can be eliminated. When the environmental improvement material of the present invention is dispersed such as to cover the garbage from above, antibacterial and antiseptic effects can be better achieved. At the same time, basic odors, of which a typical example is ammonia odor, can be eliminated.

In addition to the above, the environmental improvement material of the present invention can be used as a material that effectively improves the environment, such as an antibacterial or antiseptic filter for automobiles, as an antibacterial or antiseptic agent for educational and child-care facilities and food service facilities, an antibacterial or antiseptic agent for dining and drinking establishments such as diners and restaurants, an antibacterial or antiseptic agent for lodging facilities, and an antibacterial or antiseptic agent for pet shops and veterinary hospitals, as well as in any other field that requires suppression and elimination of bacteria in industrial or living environments.

As described above, as a result of the environmental improvement material composed of Wakkanai diatom shale that has been subjected to a sterilization treatment of the present invention, general bacterial including E. coli and staphylococcus aureus can be reliably disinfected or sterilized, and non-cellular organisms such as viruses can be reliably deactivated.

Therefore, the environmental improvement material of the present invention is not limited to the examples described above, and can be applied to a wide range of fields and achieve beneficial effects.

1. A method for manufacturing an environmental improvement material comprising:
pulverizing Wakkanai diatom shale into granules and/or a powder;
subjecting the granulated and/or powderized Wakkanai diatom shale to a sterilization treatment and imparting the Wakkanai diatom shale with a function for disinfecting, sterilizing, or deactivating microorganisms; and
forming the Wakkanai diatom shale into a state of a predetermined environmental improvement material, wherein the Wakkanai diatom shale disinfects, sterilizes, or deactivates the microorganisms.

2. The method of claim 2, wherein the sterilization treatment is a dry-heat sterilization treatment.
